(19) United States
(12) Patent Application Publication
(10) Pub. No.: US 2024/0048607 A1
(43) Pub. Date: Feb. 8, 2024

(54) LINKS FOR WEB-BASED APPLICATIONS

(71) Applicant: Google LLC, Mountain View, CA (US)

(72) Inventors: Sanjay Nathwani, Fremont, CA (US); Trevor Lu, Sydney (AU); Ibrahim Karahan, Mountain View, CA (US)

(21) Appl. No.: 17/882,746

(22) Filed: Aug. 8, 2022

(51) Int. Cl. H04L 67/02; G06F 16/958; G06F 3/04817

(52) U.S. Cl. CPC H04L 67/02; G06F 16/958; G06F 3/04817

(57) ABSTRACT

The technology enables link creation for web-based content that is part of a progressive web app or other remotely-hosted service. This includes launching a web-based application such as a progressive web application in a browser instance presented on a display device. One or more processors of a client computing device receive a selection of a content item that is presented in the browser instance. The system generates, via the one or more processors, a query to create an icon for the selected content item. In response to the query, the one or more processors create the icon for the selected content item and creating a manifest entry associating the icon with a direct link to the content item.

### BACKGROUND

Computer systems are able to utilize applications that are provided in different ways. Native apps may be configured for particular operating systems or computing configurations. Such apps would be installed directly on a user's computing device, and depending on the type of app can function in a stand-alone manner without a network connection. Web apps are remotely hosted apps, which can be accessed from the computing device via a specific uniform resource locator (URL). Certain web apps, known as progressive web apps (PWAs), are software applications delivered via the web and which are coded using one or more common formats, such as HyperText Markup Language (HTML), Cascading Style Sheets (CSS), JavaScript, etc.

PWAs, because they are web-based applications, can be used by different platforms without being tailored to a particular operating system or specific computing configuration. This can be helpful for certain offerings, such as streaming content for games or other services, e.g., movie/video streaming or enterprise-type apps. There may be many different games, videos, enterprise apps or other content items associated with a given web page, and the user of computing device may need or want access to a number of those apps. There is a technical challenge with providing quick and seamless access to multiple content items from the given web page via the computing device's user interface.

### BRIEF SUMMARY

Aspects of the technology provide a technical solution that enables efficient access to selected content provided via a web app, such as a PWA. Individual icons are created for each content item of interest, which can be positioned in a specific region of the graphical user interface on the user's computing device. A manifest entry is created for each new content item and associated icon, wherein the manifest entries are each tied to a specific URL for the respective content. The icons can be badged to indicate that they come from or are associated with a particular website. Selection of a given icon launches an instance of the content item, such as to run a gaming app, begin streaming of a movie, or open a word processing application hosted by the website.

According to one aspect, a computer-implemented method comprises: launching, by one or more processors of a computing device, a web-based application in a browser instance presented on a display device; receiving, by the one or more processors, a selection of a content item that is presented in the browser instance; generating, by the one or more processors, a query to create an icon for the selected content item; and in response to the query, the one or more processors creating the icon for the selected content item and creating a manifest entry associating the icon with a direct link to the content item.

The method may further comprise presenting the icon in a selected region of a graphical user interface for display on the display device. The selected region of the graphical user interface may be separate from the browser instance. Alternatively or additionally, the manifest entry includes a name of the selected content item, information identifying the icon, and a uniform resource locator that identifies the direct link to the content item in the web-based application. Alternatively or additionally, the manifest entry is part of a manifest file that includes information about the web-based application.

Alternatively or additionally, creating the icon for the selected content item further includes creating a badge, in which the badge includes a graphical identifier associated with the web-based application. The graphical identifier may have a same appearance as an icon of the web-based application. Alternatively or additionally, the badge may intersect or adjoins the icon.

Alternatively or additionally, the web-based application is a progressive web application. In this case, the progressive web application may be a first progressive web application and the selected content item is a second progressive web application. Alternatively or additionally, the selected content item may be one of a plurality of enterprise applications hosted by the progressive web application.

Alternatively or additionally, the method may further comprise: identifying that the icon for the selected content item has been selected; obtaining the direct link to the selected content item from the manifest entry; and automatically launching a direct browser instance using the direct link to the selected content item.

Alternatively or additionally, the method may further comprise: identifying that the icon for the selected content item has been selected; obtaining the direct link to the selected content item from the manifest entry; and accessing the direct link to install media content of the selected content item on the computing device.

Alternatively or additionally, the manifest entry may include a pointer to a last viewing spot of the selected content item. In this case the method further comprises: identifying that the icon for the selected content item has been selected; obtaining the direct link to the selected content item from the manifest entry; and automatically launching media content of the selected content item on the computing device starting at the last viewing spot. This method may further comprise updating the pointer of the manifest entry upon exiting the media content.

According to another aspect, a computing system comprises memory configured to store a manifest file, a display module having a display engine configured to generate a graphical user interface, and one or more processors operatively coupled to the memory the display module. The one or more processors are configured to: launch a web-based application in a browser instance presented by the display module on a display device; receive a selection of a content item that is presented in the browser instance; and generate a query to create an icon for the selected content item. In response to the query, the one or more processors are configured to create the icon for the selected content item; create a manifest entry associating the icon with a direct link to the content item; and store the created manifest entry in the manifest file.

Creation of the icon for the selected content item may further include creation of a badge, the badge including a graphical identifier associated with the web-based application.

Alternatively or additionally, the one or more processors are further configured to: identify that the icon for the selected content item has been selected; obtain the direct link to the selected content item from the manifest entry; and launch a direct browser instance using the direct link to the selected content item.

Alternatively or additionally, the one or more processors are further configured to: identify that the icon for the selected content item has been selected; obtain the direct link to the selected content item from the manifest entry; and access the direct link to install media content of the selected content item on the computing system.

Alternatively or additionally, the manifest entry includes a pointer to a last viewing spot of the selected content item, and the one or more processors are further configured to: identify that the icon for the selected content item has been selected; obtain the direct link to the selected content item from the manifest entry; and launch media content of the selected content item on the computing system starting at the last viewing spot.

### BRIEF DESCRIPTION OF THE DRAWINGS

FIGS. 1A-C illustrate examples progressive web apps for use with aspects of the technology.

FIGS. 2A-E illustrate an interface according to aspects of the technology.

FIG. 3 illustrates a badging example in accordance with aspects of the technology.

FIG. 4 illustrates a flow diagram in accordance with aspects of the technology.

FIG. 5 illustrates a computing device in accordance with aspects of the technology.

FIG. 6 is a block diagram of the computing device of FIG. 5 in accordance with aspects of the technology.

FIG. 7 illustrates another computing device in accordance with aspects of the technology.

FIG. 8 is a block diagram of the computing device of FIG. 7 in accordance with aspects of the technology.

FIG. 9 illustrates a further example computing device in accordance with aspects of the technology.

FIG. 10 illustrates a streaming example in accordance with aspects of the technology.

FIGS. 11A-B illustrate an example network in accordance with aspects of the technology.

### DETAILED DESCRIPTION

The technology enables link creation for web-based content that is part of a progressive web app or other remotely-hosted service. When the app or service is launched by a user's computing device, such as in a browser instance, one or more content items associated with the app or service are presented in the browser instance. A given content item may be accessed by selecting it in the browser instance. Then the user of the computing device may authorize creation of a direct link to the given content item. The direct link includes a URL to the given content item, and has an icon associated with the URL. The icon is displayed in a launch tray or other region of the graphical display of the computing device. Then, upon selection of the icon by the user, the given content item is launched without having to go through the browser instance for the progressive web app or other remotely-hosted service.

Unless otherwise stated, the disclosed examples, embodiments and scenarios are not mutually exclusive, but may be implemented in various combinations to achieve unique benefits. As these and other variations and combinations of the features discussed above can be utilized without departing from the subject matter defined by the claims, the description of the implementations should be taken by way of illustration rather than by way of limitation of the subject matter defined by the claims. In addition, the provision of the scenarios and examples described herein, as well as clauses phrased as “such as,” “including” and the like, should not be interpreted as limiting the subject matter of the claims to the specific examples or scenarios; rather, the examples and scenarios are intended to illustrate exemplary implementations. Further, the same reference numbers in different drawings can identify the same or similar elements.

### Example Scenarios

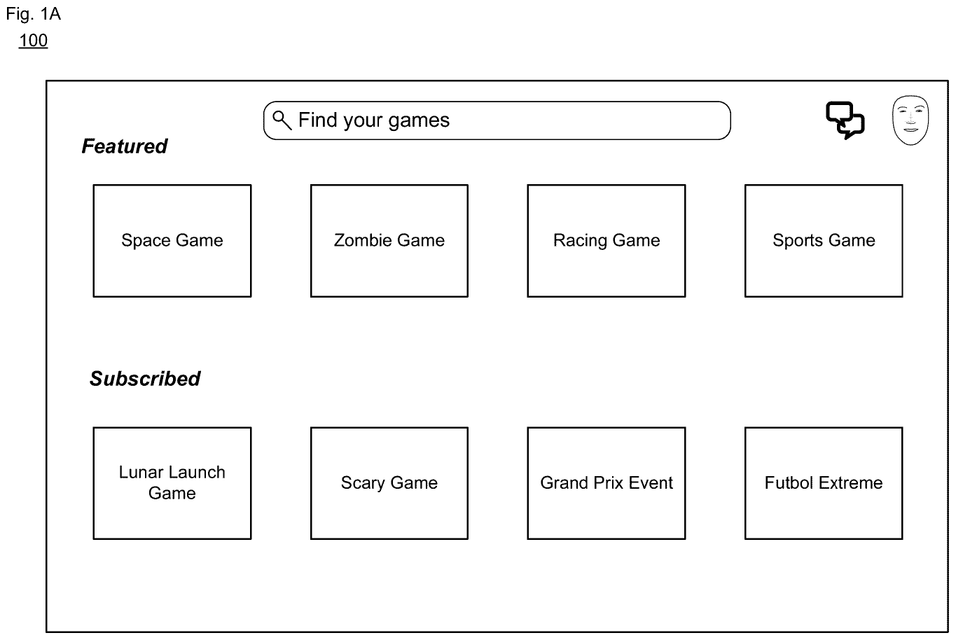

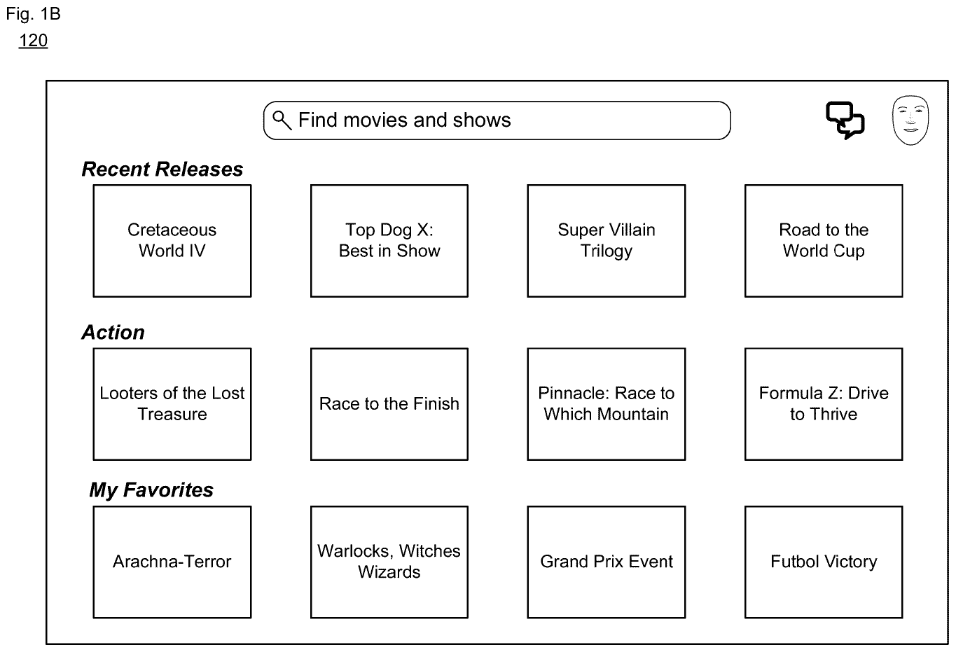

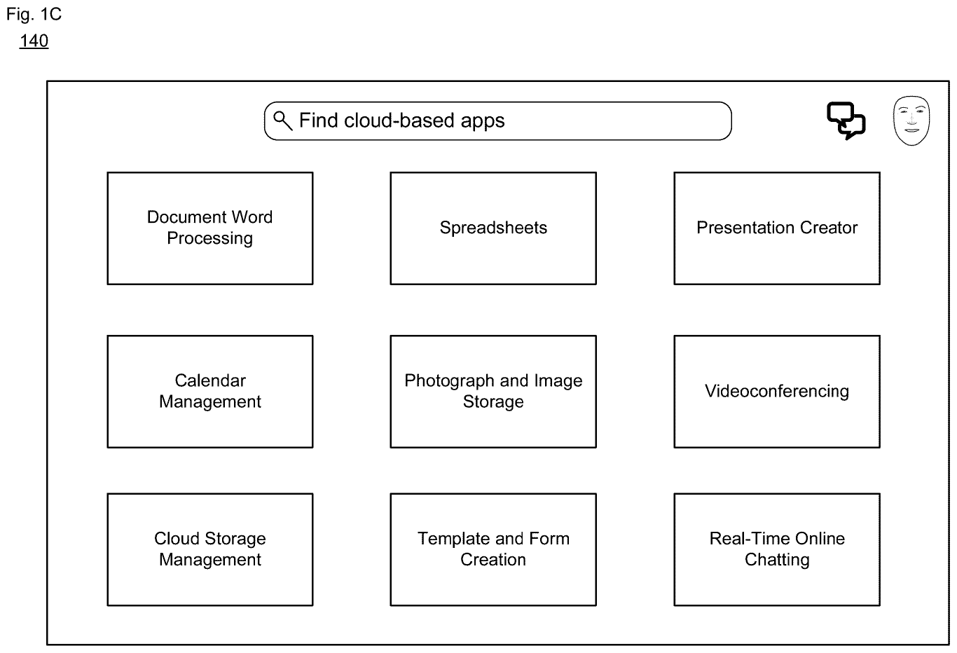

FIGS. 1A-C illustrate examples of web apps for various types of content. FIG. 1A illustrates a first view 100 of a gaming website. Here, a graphical user interface (GUI) on a display screen of the user's computing device lists various games hosted by a cloud gaming service. For instance, a cloud-based gaming service may promote one or more featured games that users can play, as well as any subscribed games for which the user has a subscription. Selecting any of the listed games in the GUI would initiate gaming where the service streams the selected game to the user's device from a remote server, for presentation on the display screen(s) of the user's device. FIG. 1B illustrates a second view 120 for a move and show streaming service. Here, the GUI lists recent releases, action shows and user favorites, which may be associated with the user's account. And FIG. 1C illustrates a third view 140 for a cloud-based enterprise system. This interface shows different apps hosted by the enterprise system, such as a document word processing app, a spreadsheets app, a presentation creator app, a calendar management app, a photograph and image storage app, a videoconferencing app, a cloud storage management app, a template and form creation app, and a real-time online chatting app. These examples are non-limiting, and other types of apps or different types of web-based services are possible.

According to one aspect of the technology, the games, video content, enterprise apps or other content from a particular provider may be treated as different apps by the client computing device. The system can support spawning a PWA from another PWA. For instance, while the client device GUI may provide an icon that enables the user to directly go to the website of a PWA such as a gaming website, video streaming service or enterprise service, the system allows the user to create individual icons for specific content items on the web page of the PWA.

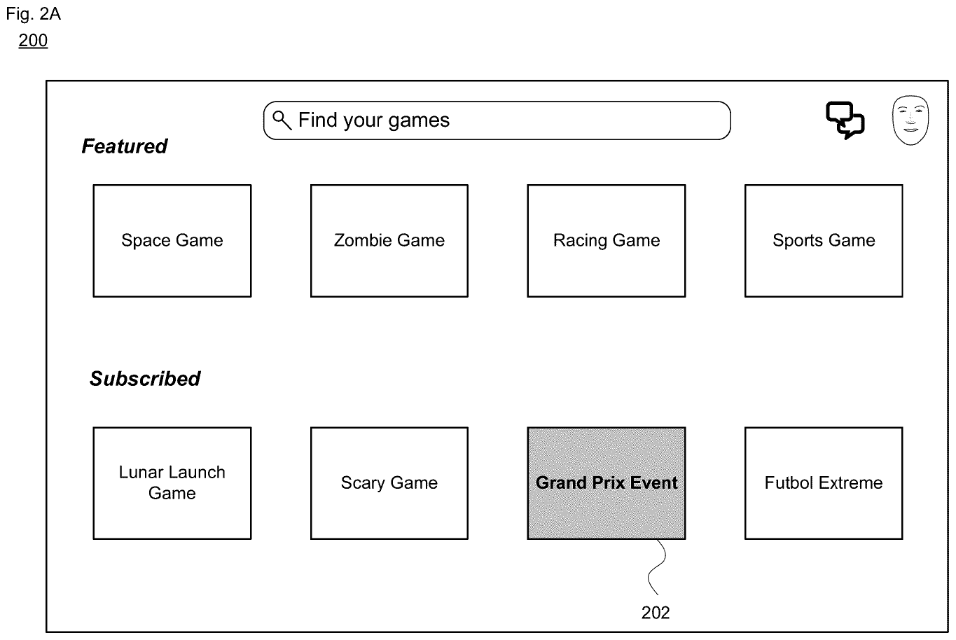

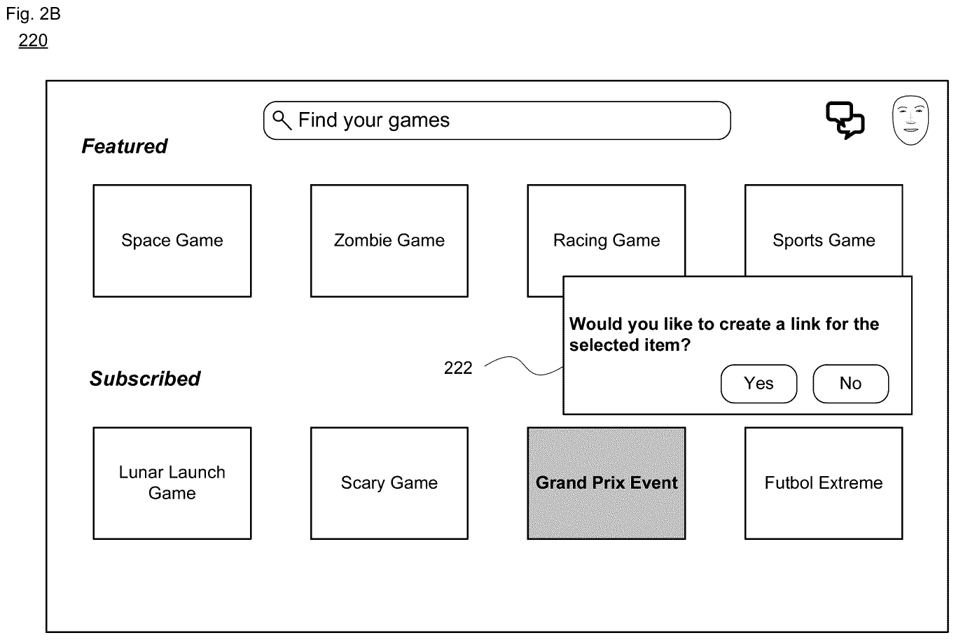

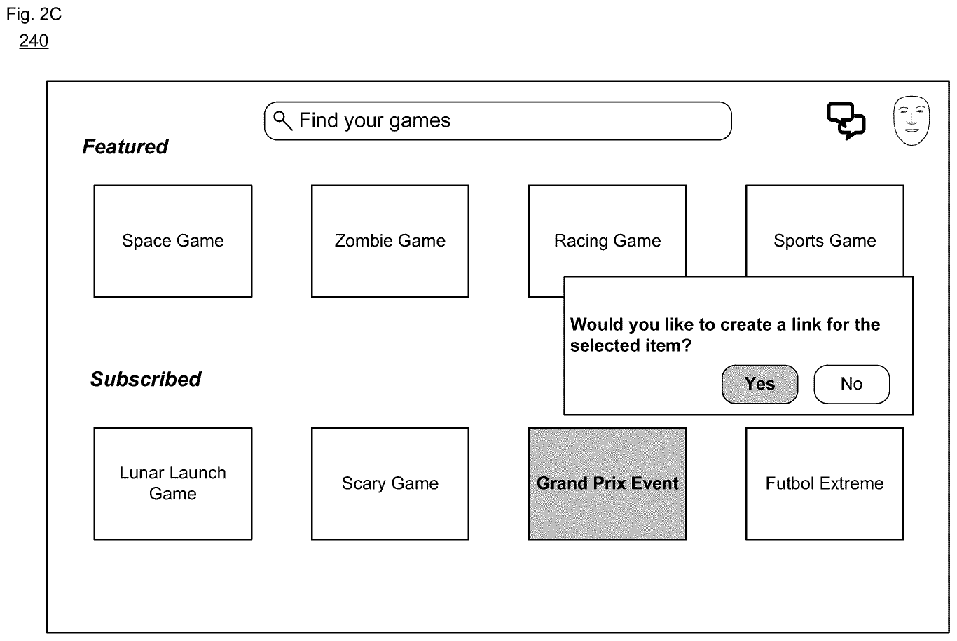

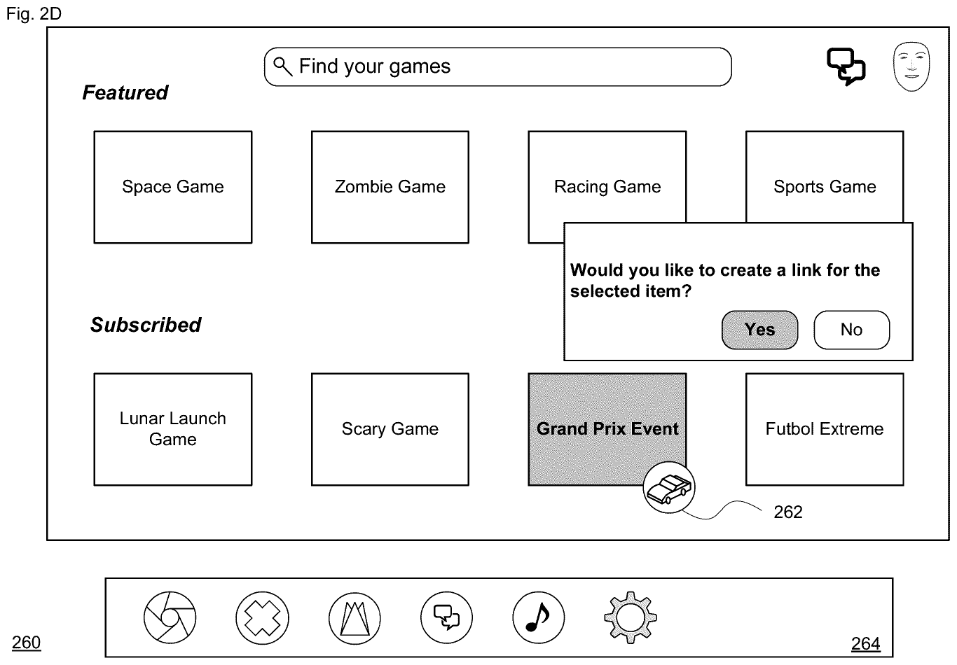

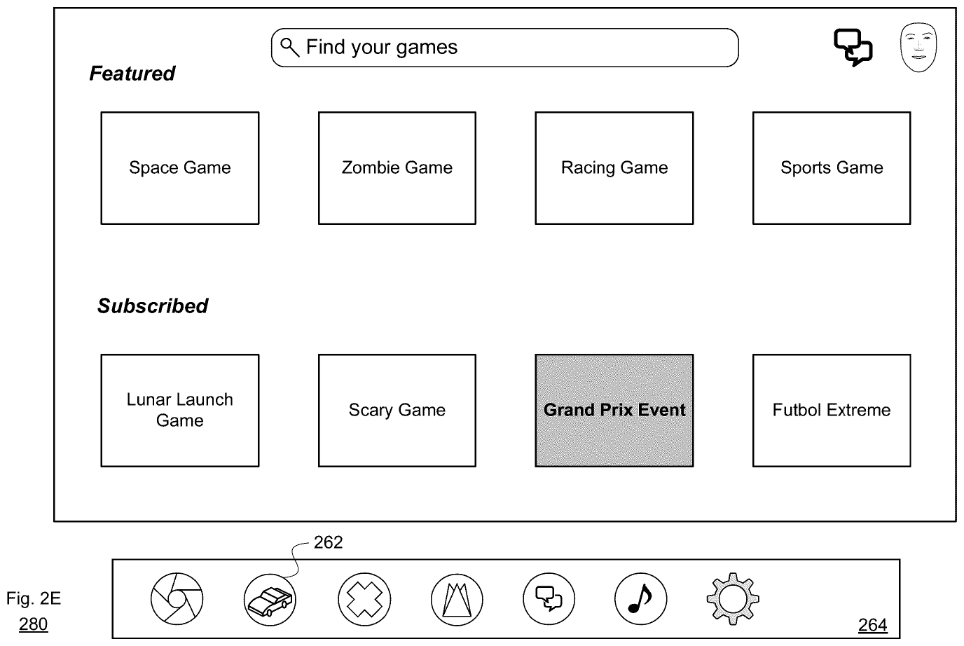

FIG. 2A illustrates a view 200 in which the user has selected a particular content item 202 (e.g., “Grand Prix Event”) from a gaming PWA. The selection may be made using any user input tool supported by the client computing device, such as a mouse press, keyboard press, touch screen press, verbal instruction, gesture, gaze input, etc. In one example, the content item may include a selectable button or other graphic that enables the user to pin it onto the GUI of their device. As shown in view 220 of FIG. 2B, a system notification 222, such as a pop-up, may then presented to ask the user whether they would like to create a link for the selected item of content. As shown in view 240 of FIG. 2C, upon selecting “Yes” or otherwise communicating the permission, a link to the selected content is created. As shown in view 260 of FIG. 2D, icon 262 is created. This figure also shows a tray 264, shelf or other graphical section that is presented in the GUI for launching application. And as shown in view 280 of FIG. 2E, the icon 262 can be placed by the user anywhere along the tray 264, which can include rearranging any of the other icons already in the tray. At this point the icon 262 is pinned to the tray. In one scenario, if the content item has been updated or otherwise changed since the user last viewed or accessed it, an indicator may be presented on or otherwise associated with the icon 262 (e.g., a change in shading, color, size or shape, or a badge included with the icon 262, which indicates to the user that there has been some change.

When the user authorizes creating of the icon to launch the selected content item, the client computing device creates a manifest entry. The manifest entry, which may be formatted in JavaScript Object Notation (JSON), associates the specific URL for the selected content item to the particular icon. By way of example, the manifest entry may include the name of the content item (or the app associated with the content item), the icon to be used, and the URL to be opened when the icon is selected, in order to launch the content item. The manifest entry may additionally include a pointer to a last viewing (or listening) spot of the corresponding content item, so that upon selection of the icon the media associated with the content item can be launched at that viewing (or listening) spot. The pointer may be automatically updated by the system upon closing the content item. The manifest entry may be stored in a manifest file in a database of the client computing device. In one aspect, the manifest entry associated with the icon of the content item is associated with a specific user account of the computing device. Thus, other users who log on to the device would not have the icon available in the launch tray. In another aspect, if the user logs into another device, they would still see their pinned apps

Selection of a given icon launches an instance of the content item, such as to run a gaming app, stream media, or open an enterprise application. For instance, selecting a media streaming icon for selected content may install a movie or a playlist on the user's device, launch a movie or show at the last viewing spot during the movie or show, or deep link to a specific section of an online newspaper (e.g., the sports section, op-ed section, lifestyle section, local or national news section, etc.).

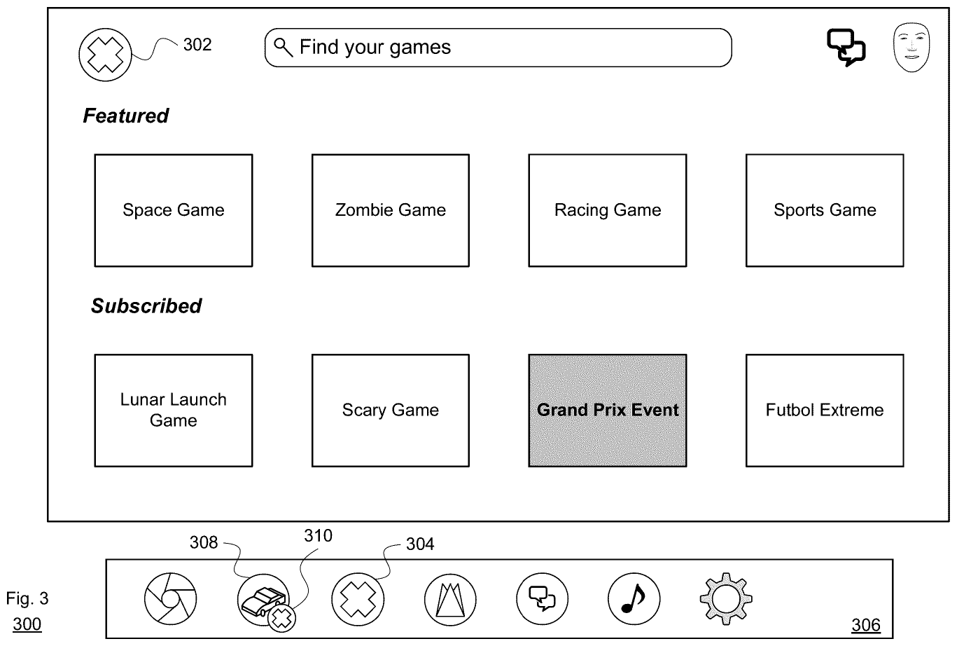

The icons can be badged to indicate that they come from or are otherwise associated with a particular website. For instance, view 300 of FIG. 3 illustrates a badging example. Here, a gaming website has its own badge or other graphical identifier 302. A link 304 to the gaming website is in launch tray 306, which has the same or similar indicia as the identifier 302. In this example, the user has authorized the system to create icon 308, which is in the launch tray 306. As shown, icon 308 includes a badge 310 which has the same or similar appearance to the link 304 and/or the identifier 302. The badge 310 may intersect, adjoin or be spaced apart from the icon 308.

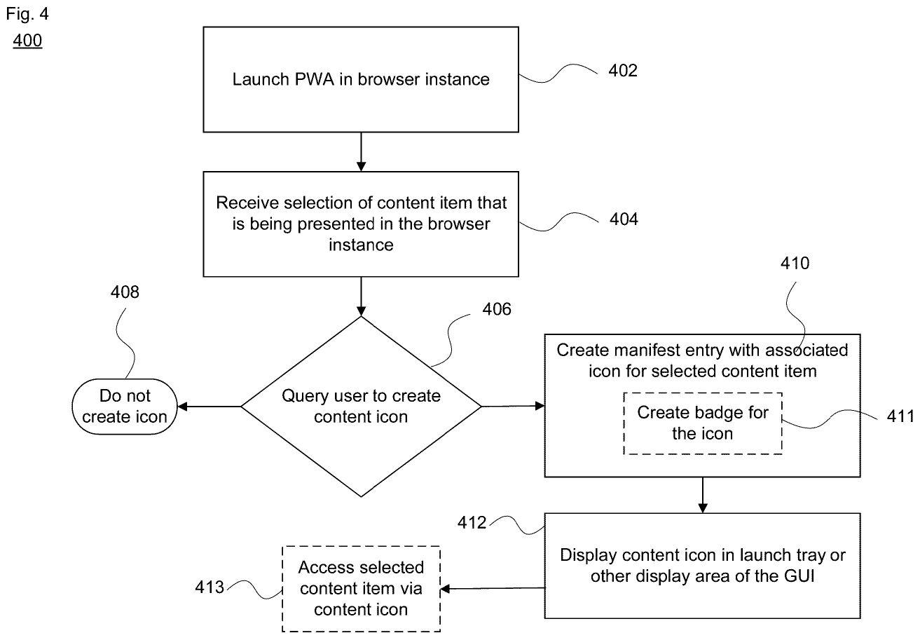

FIG. 4 illustrates an example process 400 in accordance with the overall process. At block 402, the system launches a PWA (or other web app) in a browser instance on the user's computing device. At block 404, the system receives a selection of a given content item that is being presented in the browser instance of the PWA (e.g., the Grand Prix Event 202 of FIG. 2A). As noted above, this selection may be received from any type of user input supported by the computing device. At block 406, the system can generate a query (e.g., a graphical or audible query) to the user asking whether the user wants to create a launchable icon for the selected content item. At block 408, if the user chooses not to, then no icon is created and the process concludes. However, if the user chooses to create a launchable icon, then at block 410 the system creates a manifest entry that is associated with a particular icon for the content item. As shown by dashed sub-block 411, this can optionally include creating a badge for the icon that is associated with the PWA (or the service or website that provides the PWA). Then, at block 412, the content icon is displayed in a launch tray or other area of the GUI, so that the user may easily launch it. Upon selection of the content icon by the user, as shown by dashed block 413, the client device accesses the selected content item directly from the remote system, without having to go through the PWA. This can include obtaining the direct link to the content item from the manifest entry, and automatically launching a browser instance using the direct link to the content item. Thus, the system provides a technical solution to the problem of efficiently accessing and launching a content item that is not locally stored on the user's computing device. In one scenario, if the content item has been updated or otherwise changed since the user last viewed it, an indicator may be presented on or otherwise associated with the content icon, which indicates to the user that there has been some change. The technical solution provides links for web-based apps on the user's computing device. Upon creation of the icon, attributes associated with the content item are saved in a manifest entry that allow for direct access to the content item, even though it is hosted through a PWA.

### Example Computing Devices

FIG. 5 illustrates view 500 showing an example client computing device 502, such as a laptop computer, which can be used with the above-described technology. In this example, there is a display 504 for visually presenting content via GUI 506, and a user input section 508 having a keyboard 510 and a trackpad 512 as different user inputs. A microphone (not shown) may be provided for audible input. The display 504 may be configured as a user input (e.g., a touchscreen). The keyboard 510 may be a virtual keyboard, for instance as part of another display. While one trackpad 512 is shown, the device may have two or more trackpads arranged thereon. The device may contain additional user inputs (e.g., a mouse, audio and/or gesture-based inputs).

An integrated webcam 514 can be used for videoconferences, interactive gaming, etc. Indicator 516, such as an LED, may be illuminated to alert a user whenever the integrated webcam is in use. The client device may also include one or more other sensors 518, which may be used to supplement visual information obtained by the webcam 514. By way of example, the one or more other sensors may include an additional imaging device, an RF- or ultrasonic-based motion sensor, such as to help identify gestures by the user or act as a human presence detector. The integrated webcam 514 may comprise two (or more) imaging devices, which can enable advanced head or body tracking, such as via a human presence sensor module (not shown).

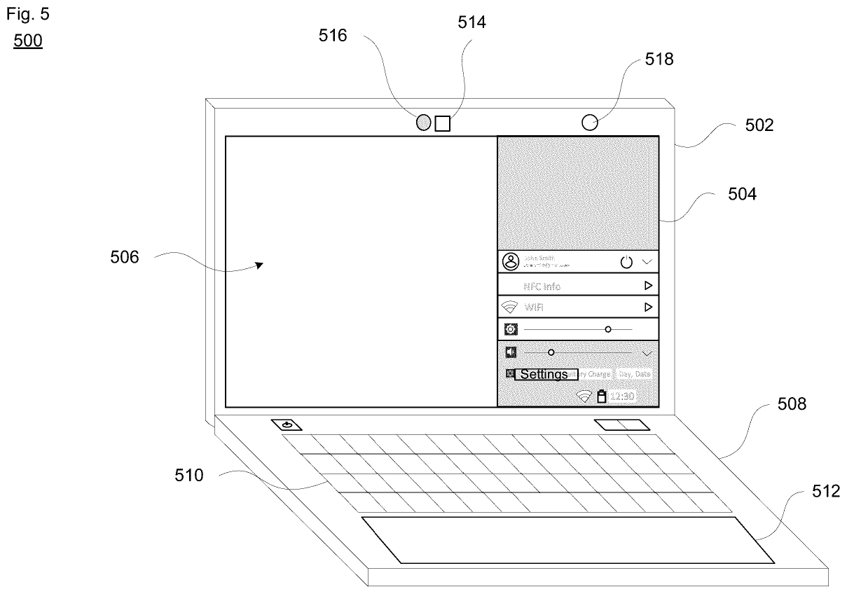

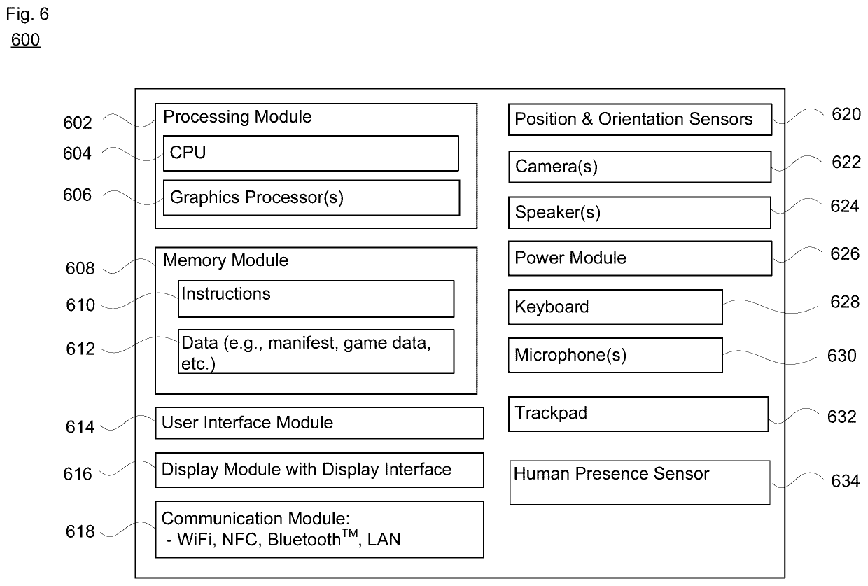

FIG. 6 illustrates a block diagram of an example client computing device 600, such as the laptop shown in FIG. 5 (e.g., a tablet PC or netbook) or a desktop PC. As shown, the client computing device 600 includes a processing module 602 having one or more computer processors such as a central processing unit 604 and/or graphics processors 606, as well as memory module 608 configured to store instructions 610 and data 612. The processors may or may not operate in parallel, and may include graphics processing units (GPUs), tensor processing units (TPUs), ASICs, controllers, and other types of hardware-based circuitry. The processors are configured to receive information from a user through user interface module 614 and information from remote devices via communication module 618, and to present information to the user on one or more display devices of display module 616 having a display interface.

User interface module 614 may receive commands or other input information from a user via user inputs and convert them for submission to a given processor. The user interface module may link to a web browser and other applications executed by the computing device's processing module 602. The user inputs may include one or more of a touchscreen, keyboard or keypad, trackpad, stylus, microphone, or other types of input devices (e.g., a gesture-based or gaze-based input). The display module 616 may include a display engine configured to generate a GUI, and may comprise appropriate circuitry for driving the display device to present graphical and other information to the user, such as at a particular resolution and refresh rate. By way of example, the graphical information may be generated by the graphics processor(s) 606, while CPU 604 manages overall operation of the client device 600. The graphical information may display responses to user queries or other content on the display module 616. For instance, the processing module may run a browser application, messaging application, gaming application, enterprise application or other service using instructions and data stored in memory module 608, and present information associated with the corresponding application or other service to the user via the display module 616. The memory module may include a database or other storage for application-related information, etc.

Memory module 608 can be implemented as one or more of a computer-readable medium or media, a volatile memory unit or units, or a non-volatile memory unit or units. The memory module 608 may include, for example, flash memory and/or NVRAM, and may be embodied as a hard-drive or memory card. Alternatively or additionally, the memory module 608 may also include removable media (e.g., DVD, CD-ROM or USB thumb drive). One or more regions of the memory module 608 may be write-capable while other regions may comprise read-only (or otherwise write-protected) memories. In one implementation, a computer program product is tangibly embodied in an information carrier. Although FIG. 6 functionally illustrates the processor(s), memory module, and other elements of client computing device 600 as being within the same overall block, such components may or may not be stored within the same physical housing. For example, some or all of the instructions and data may be stored on an information carrier that is a removable storage medium (e.g., optical drive, high-density tape drive or USB drive) and others stored within a read-only computer chip.

The data 612 may be retrieved, stored, or modified by the processors in accordance with the instructions 610. The data 612 may include streamed content received from a remote system (e.g., game data or buffered movie data), manifest data used for links for web-based content, etc. The manifest data can include a manifest file having a set of manifest entries that are each associated with individual content items for one or more PWAs, including the icons corresponding to each content item. For instance, the data may be stored in computing device registers, in a relational database as a table having a plurality of different fields and records, XML documents or flat files. The data may also be formatted in any computing device-readable format.

The instructions 610 may be any set of instructions to be executed directly (such as machine code) or indirectly (such as scripts) by the processor(s). For example, the instructions may be stored as computing device code on the computing device-readable medium. In that regard, the terms “instructions” and “programs” may be used interchangeably herein. The instructions may be stored in object code format for direct processing by the processor(s), or in any other computing device language including scripts or collections of independent source code modules that are interpreted on demand or compiled in advance.

As also shown in FIG. 6, the client device 600 includes the communication module 618 for communicating with other devices and systems, including other client devices, servers and databases. The communication module 618 includes a wireless transceiver; alternatively, the module may alternatively or additionally include a wired transceiver. The client device 600 may communicate with other remote devices via the communication module 618 using various configurations and protocols, including short range communication protocols such as near-field communication (NFC), Bluetooth™, Bluetooth™ Low Energy (BLE) or other ad-hoc networks, the Internet, intranets, virtual private networks, wide area networks, local networks, private networks using communication protocols proprietary to one or more companies, Ethernet, WiFi and HTTP, and combinations of the foregoing. By way of example, the device may employ a web-based real time communication, such as WebRTC, which enables web-based applications to stream audiovisual content and to directly exchange data between browser instances.

The example client device 600 as shown also includes one or more position and orientation sensors 620. The position and orientation sensors 620 are configured to determine the position and orientation of one or more parts of the client computing device 600. For example, these components may include a GPS receiver or other global positioning component to determine the device's latitude, longitude and/or altitude as well as an accelerometer, gyroscope or another direction/speed detection device such as an inertial measurement unit (IMU). The client device 200 may also include one or more camera(s) 622 for capturing still images and recording video streams such as the integrated webcam as discussed above, speaker(s) 624. Power module 626 provides power to the various system components. In addition, user inputs include a keyboard 628 and a microphone 630, which may comprise a microphone array having one or more transducers or other microphone elements distributed at various points along the housing of the computing device. Trackpad 632 may include either a capacitive touch sensor unit or a piezoelectric sensor unit (or both). A human presence sensor module 634 may also be provided. This module may use imagery from the camera(s) 622, audio information from the speakers 624 and/or other sensor information to determine whether a person is in front of the computing device within some threshold distance (e.g., sitting or standing within 3-10 feet of the device).

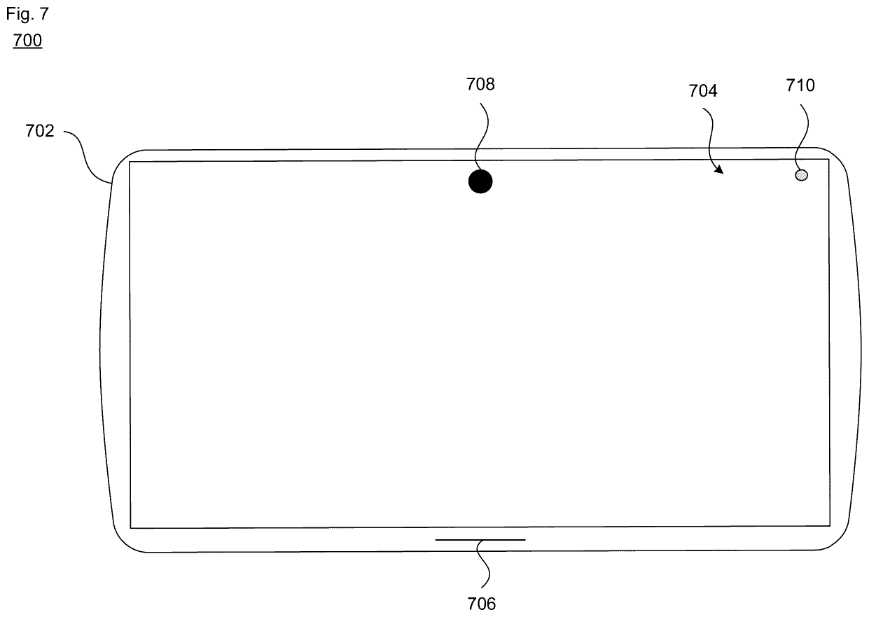

FIG. 7 illustrates a view 700 showing an example handheld-type client device 702, such as a smartphone, personal digital assistant (PDA) or wearable (e.g., a smartwatch). In this example, there is a display 704 for visually presenting content. The display 704 may also be configured as a user input (e.g., a touchscreen), and may present a launch tray for PWA-associated icons as described above. A microphone 706 may be provided for audible input. A camera 708 can be used for capturing photos, videoconferences, interactive gaming, etc. The camera 708 may be integrated as part of the display module, or may be disposed along a bezel around the perimeter of the display. Indicator 710, such as an LED, may be illuminated to alert a user when the camera 708 is in use.

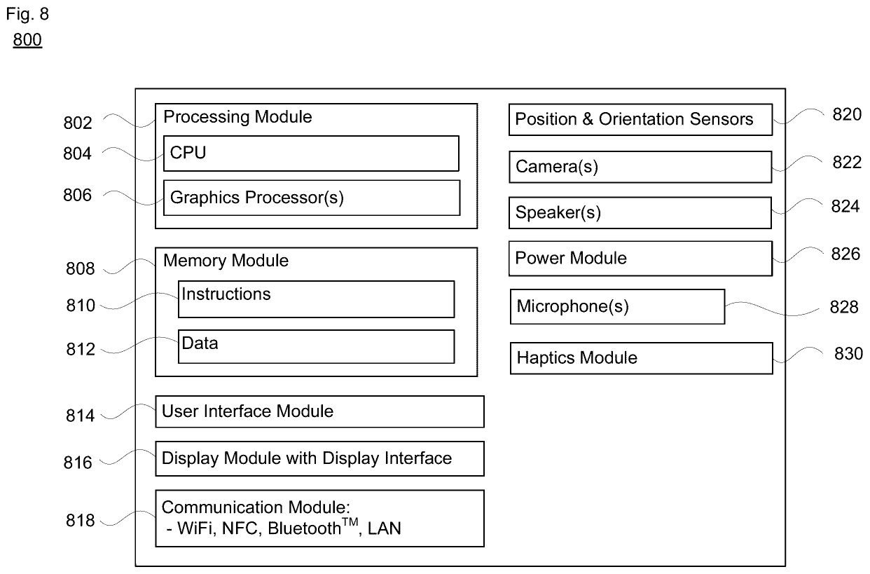

FIG. 8 illustrates a block diagram of an example handheld client portable device 800, such as the smartphone shown in FIG. 7. Similar to the configuration described above with regard to FIG. 6, the client device 800 includes a processing module 802 having one or more processors such as a central processing unit 804 and/or graphics processors 806, as well as memory module 808 configured to store instructions 810 and data 812. The processors are configured to receive user input from a user through user interface module 814, and to present information to the user on one or more display devices of the display module 816 having a display interface. In this kind of portable client device, there may be no keyboard, or a virtual keyboard (and/or virtual mousepad) may be presented on the display.

User interface module 814 may receive commands or other input information from a user via user inputs and convert them for submission to a given processor. The user interface module may link to a web browser and other applications executed by the device's processing module 802. The user inputs may include one or more of a touchscreen, stylus, microphone, spoken, gesture or other types of input devices. The display module 816 may comprise appropriate circuitry for driving the display device to present graphical and other information to the user. By way of example, the graphical information may be generated by the graphics processor(s) 806, while CPU 804 manages overall operation of the client mobile device 800. The graphical information may display responses to user queries on the display module 816.

As with memory module 608, memory module 808 can be implemented as one or more of a computer-readable medium or media, a volatile memory unit or units, or a non-volatile memory unit or units. The memory module 808 may include, for example, flash memory and/or NVRAM, and may be embodied as a hard-drive or memory card. One or more regions of the memory module 808 may be write-capable while other regions may comprise read-only (or otherwise write-protected) memories.

As also shown in FIG. 8, the client device 800 includes a communication module 818 for communicating with other devices and systems, including other client devices, servers, and databases. The communication module 818 includes a wireless transceiver. The client device 400 may communicate with other remote devices via the communication module 818 using various configurations and protocols, including short range communication protocols such as near-field communication (NFC), Bluetooth™, Bluetooth™ Low Energy (BLE) or other ad-hoc networks, the Internet, intranets, virtual private networks, wide area networks, local networks, private networks using communication protocols proprietary to one or more companies, WiFi and HTTP, and combinations of the foregoing. As noted above with regard to FIG. 6, device 800 may employ WebRTC (or another type of web-based real time communication).

The example client device 800 as shown also includes one or more position and orientation sensors 820. The position and orientation sensors 820 are configured to determine the position and orientation of one or more parts of the client mobile device 800. For example, these components may include a GPS receiver or other global positioning component to determine the device's latitude, longitude and/or altitude as well as an accelerometer, gyroscope or another direction/speed detection device such as an inertial measurement unit (IMU). The mobile device 800 may also include one or more camera(s) 822 for capturing still images and recording video streams such as the integrated camera as discussed above, speaker(s) 824. Power module 826 provides power to the various system components. In addition, user inputs may include a microphone 828, which may comprise a microphone array having one or more transducers or other microphone elements distributed at various points along the housing of the computing device. A haptics module 830 may be used to give haptic feedback to the user. The haptic feedback may be associated with one or more parts of the device housing and/or may be integrated with a touchscreen.

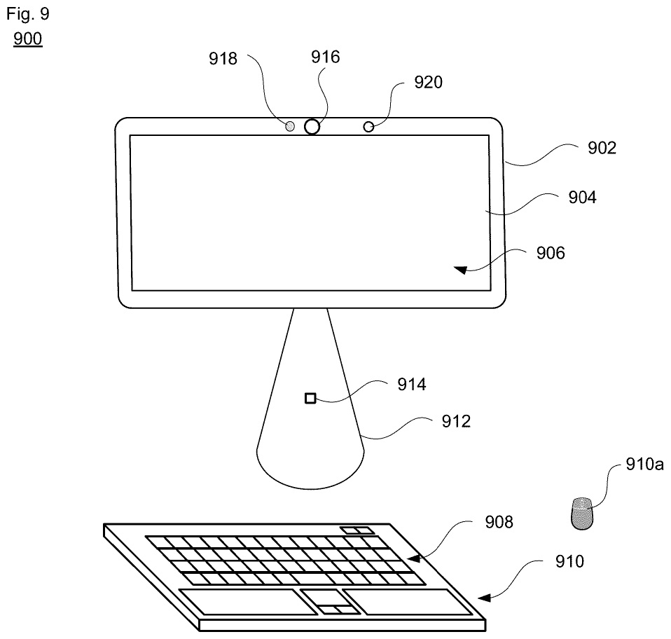

View 900 of FIG. 9 illustrates yet another example computing device, which can be a desktop-type household computing device 902, or other in-home device such as a smart display. In this example, display 904 is configured to present a GUI 906, and be configured for tactile input using a stylus or touch input with the user's finger(s). As shown, the computing device may employ a wireless keyboard 908 and/or one or more trackpads or mousepads 910, which may be part of one unit or the keyboard may be separate from the trackpad/mousepad or a mouse-based input 910a. The computing device 902 has a stand 912. One or more microphones 914 may be disposed along the stand and/or disposed along the housing of the computing device 502. While the computing device may be fixedly mounted to the stand 912, in an alternative configuration the screen (with the integrated components) can be detached from the stand, allowing a user to carry around the home and use remotely based on battery power, such as a smart display. In other words, the computing device 902 can comprise an integrated housing that is (optionally removably or releasably) coupled to the stand 912.

A webcam or other integrated camera 916 that may include a privacy shutter or other feature to disable image-taking is positioned along the housing of the computing device 902, which can be used for videoconferences, interactive gaming, etc. Indicator 918, such as an LED, may be illuminated to alert a user whenever the webcam 916 is in use. The device may include a separate camera or other imaging device 920 that is part of a human presence sensor module. As shown, the webcam 916 and the imaging device 920 may each be positioned along a top bezel of the integrated client device housing. In some examples these devices may be located in different position along the integrated housing. The integrated camera 916 may be used as part of the presence sensor module instead of or in addition to imaging device 920. In other words, the presence sensor comprises an image sensor configured to take one or more images. The presence sensor can be configured to detect presence of one or more people within a threshold distance from the client computing device. These and other components of the computing device may be equivalent to those described above with regard to FIG. 6 or FIG. 8.

### Example Network

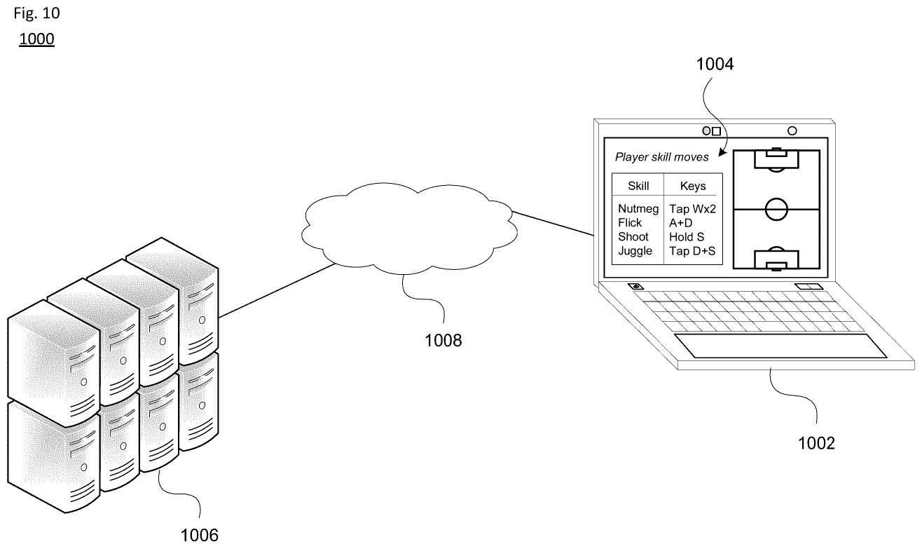

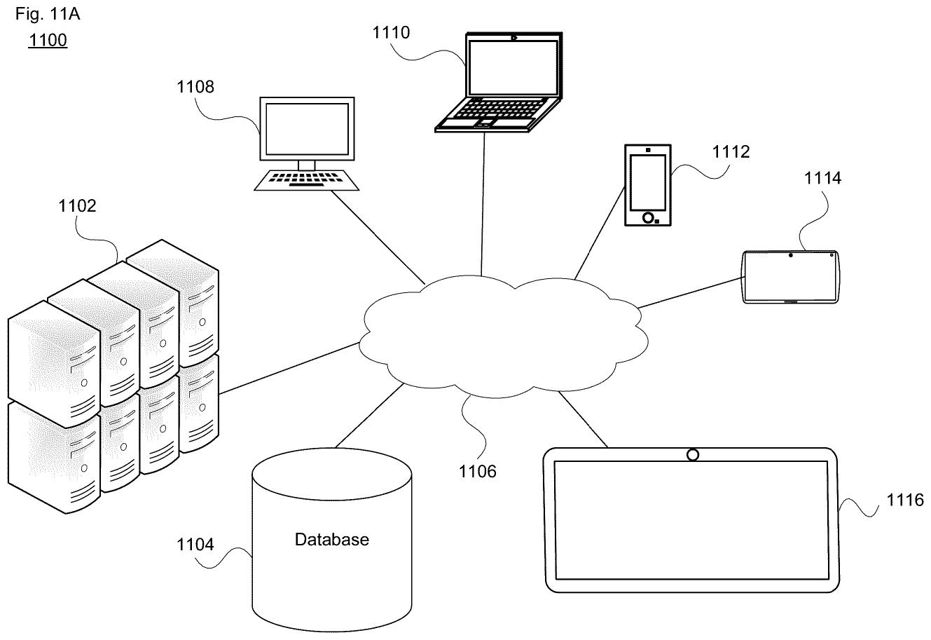

One or more computing devices may connect to one another, e.g., for cloud gaming, shared media streaming or enterprise connectivity, over a network. FIG. 10 illustrates an example 1000 in which, upon selection of an icon in the launch tray, the system opens a direct link to a corresponding game in a cloud-based PWA. Computing device 1002 is then streamed a game 1004 by a cloud gaming service 1006 via network 1008.

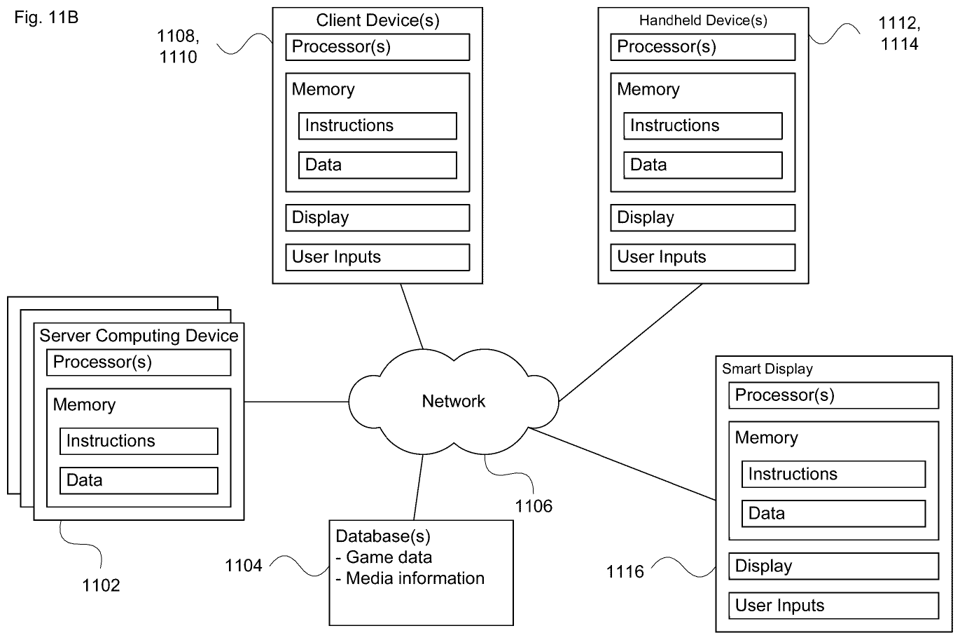

FIGS. 11A and 11B are pictorial and functional diagrams, respectively, of an example system 1100 that includes a plurality of computing devices and databases connected via a network. For instance, computing device(s) 1102 may be a cloud-based server system that provides or otherwise supports one or more cloud-based enterprise apps, games, multimedia content or other programs. Database 1104 may store messaging app information, game data, user profile information, and/or other information.

The server system may access the databases via network 1106. Client devices may include one or more of a desktop computer 1108 or a laptop or tablet PC 110. Other client devices may include handheld devices including a personal communication device such as a mobile phone or PDA 1112 or a tablet 1114. Another example client device is a large screen display (e.g., a smart display) 1116.

In one example, computing device 1102 may include one or more server computing devices having a plurality of computing devices, e.g., a load balanced server farm or cloud computing system, that exchange information with different nodes of a network for the purpose of receiving, processing, and transmitting the data to and from other computing devices. For instance, computing device 902 may include one or more server computing devices that are capable of communicating with any of the computing devices 1108-1116 via the network 1106. This may be done as part of hosting one or more collaborative apps (e.g., a videoconferencing program, an interactive spreadsheet app or a multiplayer game) or services (e.g., a movie streaming service or interactive game show where viewers can provide comments or other feedback).

As shown in FIG. 11B, each of the computing devices 1102 and 1108-1116 may include one or more processors, memory, data and instructions. The memory stores information accessible by the one or more processors, including instructions and data that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing; whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs. Alternatively, each processor may be a dedicated device such as an ASIC, graphics processing unit (GPU), tensor processing unit (TPU) or other hardware-based processor. Although FIG. 11B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 1102. Accordingly, references to a processor or memory will be understood to include references to a collection of processors or memories that may or may not operate in parallel.

The computing devices may include all of the components normally used in connection with a computing device such as the processor and memory described above as well as a user interface subsystem for receiving input from a user and presenting information to the user (e.g., text, imagery and/or other graphical elements, audibly and/or via haptic feedback). The user interface subsystem may include one or more user inputs (e.g., at least one front (user) facing camera, a mouse, keyboard, touchscreen and/or microphone) and one or more display devices that is operable to display information (e.g., text, imagery and/or other graphical elements). Other output devices, such as speaker(s) may also provide information to users.

The user-related computing devices (e.g., 1108-1116) may communicate with a back-end computing system (e.g., server 1102) via one or more networks, such as network 1106. The network 1106, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces. In some implementations, the user-related computing devices may also communicate with one another without also communicating with a back-end computing system. This may be done via network 906, or using one or more ad hoc and/or peer to peer communication links directly between the devices.

As noted above, when selecting a content item, the system may query the user in order to create a launchable link. Thus, further to the descriptions above, a user may be provided with controls allowing the user to make an election as to both if and when systems, programs, or features described herein may enable collection of user information (e.g., a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain examples herein refer to a computing device and a mobile device performing certain operations, the technology may be used with different types of client devices, and is not limited to the specific types of devices identified in the examples. Note that the order of steps shown in the figures may be performed in a different order or in parallel, unless expressly stated otherwise herein.

Although the technology herein has been described with reference to particular implementations, it is to be understood that these implementations are merely illustrative of the principles and applications of the present technology. It is therefore to be understood that numerous modifications may be made to the illustrative implementations and that other arrangements may be devised without departing from the spirit and scope of the present technology as defined by the appended claims.

1. A computer-implemented method, comprising:
launching, by one or more processors of a computing device, a web-based application in a browser instance presented on a display device;
receiving, by the one or more processors, a selection of a content item that is presented in the browser instance;
generating, by the one or more processors, a query to create an icon for the selected content item; and
in response to the query, the one or more processors creating the icon for the selected content item and creating a manifest entry associating the icon with a direct link to the content item.

2. The method of claim 1, further comprising presenting the icon in a selected region of a graphical user interface for display on the display device.

3. The method of claim 2, wherein the selected region of the graphical user interface is separate from the browser instance.

4. The method of claim 1, wherein the manifest entry includes a name of the selected content item, information identifying the icon, and a uniform resource locator that identifies the direct link to the content item in the web-based application.

5. The method of claim 1, wherein the manifest entry is part of a manifest file that includes information about the web-based application.

6. The method of claim 1, wherein creating the icon for the selected content item further includes creating a badge, the badge including a graphical identifier associated with the web-based application.

7. The method of claim 6, wherein the graphical identifier has a same appearance as an icon of the web-based application.

8. The method of claim 6, wherein the badge intersects or adjoins the icon.

9. The method of claim 1, wherein the web-based application is a progressive web application.

10. The method of claim 9, wherein the progressive web application is a first progressive web application and the selected content item is a second progressive web application.

11. The method of claim 9, wherein the selected content item is one of a plurality of enterprise applications hosted by the progressive web application.

12. The method of claim 1, further comprising:
identifying that the icon for the selected content item has been selected;
obtaining the direct link to the selected content item from the manifest entry; and
automatically launching a direct browser instance using the direct link to the selected content item.

13. The method of claim 1, further comprising:
identifying that the icon for the selected content item has been selected;
obtaining the direct link to the selected content item from the manifest entry; and
accessing the direct link to install media content of the selected content item on the computing device.

14. The method of claim 1, wherein the manifest entry includes a pointer to a last viewing spot of the selected content item, and the method further comprises:
identifying that the icon for the selected content item has been selected;
obtaining the direct link to the selected content item from the manifest entry; and
automatically launching media content of the selected content item on the computing device starting at the last viewing spot.

15. The method of claim 14, further comprising updating the pointer of the manifest entry upon exiting the media content.

16. A computing system comprising:
memory configured to store a manifest file;
a display module having a display engine configured to generate a graphical user interface; and
one or more processors operatively coupled to the memory the display module, the one or more processors being configured to:
launch a web-based application in a browser instance presented by the display module on a display device;
receive a selection of a content item that is presented in the browser instance;
generate a query to create an icon for the selected content item;
in response to the query:
create the icon for the selected content item;
create a manifest entry associating the icon with a direct link to the content item; and
store the created manifest entry in the manifest file.

17. The computing system of claim 16, wherein creation of the icon for the selected content item further includes creation of a badge, the badge including a graphical identifier associated with the web-based application.

18. The computing system of claim 16, wherein the one or more processors are further configured to:
identify that the icon for the selected content item has been selected;
obtain the direct link to the selected content item from the manifest entry; and
launch a direct browser instance using the direct link to the selected content item.

19. The computing system of claim 16, wherein the one or more processors are further configured to:
identify that the icon for the selected content item has been selected;
obtain the direct link to the selected content item from the manifest entry; and
access the direct link to install media content of the selected content item on the computing system.

20. The computing system of claim 16, wherein the manifest entry includes a pointer to a last viewing spot of the selected content item, and the one or more processors are further configured to:
identify that the icon for the selected content item has been selected;
obtain the direct link to the selected content item from the manifest entry; and
launch media content of the selected content item on the computing system starting at the last viewing spot.
